(19) United States
(12) Patent Application Publication
(10) Pub. No.: US 2024/0400024 A1
(43) Pub. Date: Dec. 5, 2024

(54) WHEEL BRAKE DIFFERENTIAL PRESSURE CONTROL

(71) Applicant: Continental Automotive Technologies GmbH, Hannover (DE)

(72) Inventors: Viktor Reichenbach, Neu-Anspach (DE); Tobias Franke, Bad Nauheim (DE); Alexander Schönbohm, Bad Nauheim (DE); Alexander Michel, San Jose, CA (US); Jochen Müller, Marburg (DE); Marc Lenz, Neu-Anspach (DE); Gururaj Srinivasaiah, Oberursel (DE)

(73) Assignee: Continental Automotive Technologies GmbH, Hannover (DE)

(21) Appl. No.: 18/698,223

(22) PCT Filed: Sep. 27, 2022
(86) PCT No.: PCT/DE2022/200224

§ 371 Date: Apr. 3, 2024

(30) Foreign Application Priority Data
Oct. 6, 2021 (DE) 10 2021 211 245.5

(51) Int. Cl. B60T 13/68; B60T 8/171; B60T 8/172; B60T 13/74

(52) U.S. Cl. CPC B60T 13/686; B60T 8/171; B60T 8/172; B60T 13/745

(57) ABSTRACT

The disclosure relates to a method for controlling a hydraulic pressure in at least one wheel brake of a hydraulic motor vehicle braking system, wherein a system pressure is generated by an electrical pressure supply device and, by control of an in particular normally open inlet valve, having an opening current characteristic curve, a required hydraulic pressure, which is lower than the system pressure, is set in the at least one wheel brake. In order to improve the pressure control, provision is made that the inlet valve is opened by application of an opening current, in particular below the opening current characteristic curve, and is switched over from the opening current to an intermediate current on the opening current characteristic curve.

### CROSS-REFERENCE TO RELATED APPLICATIONS

This application is a national stage application, filed under 35 U.S.C. § 371, of International Patent Application No. PCT/DE2022/200224, filed on Sep. 27, 2022, which claims priority to German patent application No. 10 2021 211 245.5, filed on Oct. 6, 2021, each of which is incorporated by reference.

### TECHNICAL FIELD

The technical field relates to a method for controlling a hydraulic pressure in at least one wheel brake of a hydraulic motor vehicle braking system.

### BACKGROUND

Modern braking systems nowadays often work according to the brake-by-wire method, in which the driver has no direct hydraulic connection to the individual wheel brakes. Instead, a pressure supply device which provides the brake pressure for the individual wheel brakes is provided. However, a braking system of this type generally has more individual wheel brakes than pressure supply devices. Typically, only one single pressure supply device is provided for such a braking system. If different wheel pressures are intended to be set at the individual wheel brakes, said wheel pressures are realized by the use of the wheel valves. Even in conventional braking systems, for the implementation of assistance functions, an electrical pressure supply device builds up a brake pressure which has to be distributed by the wheel valves.

For this purpose, in the prior art, a change is made between a current below the opening current characteristic curve and a current above the opening current characteristic curve, and therefore the inlet valve is opened in pulsed form. The opening time is determined on the basis of a volume requirement.

It is known from DE 10 2012 222 897 A1 to individually control the inlet valves of the wheel brakes in an analogous manner in order to generate wheel-specific brake pressures. This means that a pressure medium volume flow provided by a pressure and volume control unit is assigned to the respective wheel brakes having a pressure change requirement. The actuating currents of the inlet valves of the selected wheel brakes are cyclically reduced in relation to one another such that the duration of the current reduction defines the proportion of the selected wheel brakes in the pressure build-up volume.

Due to parameter and model inaccuracies, such a control inevitably leads to pressure control errors, which may be problematic especially for open-loop control functions. Furthermore, such an actuation of the inlet valves leads to a high noise load.

It is therefore desirable to permit an improved pressure setting at the individual wheel brakes.

### SUMMARY

In one embodiment, a method includes an opening current firstly being applied to the inlet valve, in particular below the opening current characteristic curve in the case of normally open inlet valves, as a result of which said inlet valve is opened. The inlet valve is arranged here in particular between the pressure supply device and the wheel brake. The opening current characteristic curve specifies for various differential pressures above the inlet valve, from which current the inlet valve then no longer opens. Therefore, the valve is open below the characteristic curve and closed above the characteristic curve.

From the opening current, a switch is subsequently made to an intermediate current on the opening current characteristic curve. After a short opening period, the inlet valve is then not closed completely, but rather is transferred into an intermediate state. In the intermediate state, precisely such a volume then flows through the inlet valve that the wheel pressure can follow a pressure requirement as long as the latter does not involve changes which are too rapid. The wheel pressure is therefore set very precisely, with the noise emissions being greatly reduced.

In a one embodiment, the intermediate current is determined from the opening current characteristic curve on the basis of a pressure difference between the system pressure and the required hydraulic pressure. Therefore, the current actual wheel pressure, which in general cannot be measured directly due to the lack of appropriate sensors, and instead is calculated from a pressure model, is not required.

In another embodiment, the opening current is set on the basis of a current pressure difference via the inlet valve and/or on the basis of a required volume flow through the inlet valve. The opening current is an electrical current at which the inlet valve is clearly open. Since the current for opening the valve is therefore not simply reduced to zero, the volume flow is adjustable and the noise load is minimized.

In one embodiment, the pressure difference via the inlet valve is determined from the system pressure and the actual wheel pressure, wherein in particular the actual wheel pressure is determined from a model calculation and not from a wheel-specific pressure sensor. A system pressure may also generally be understood as meaning a wheel inlet pressure.

In another embodiment, a switch is made from the opening current to the intermediate current as soon as the actual wheel pressure has reached the setpoint wheel pressure within an acceptable deviation. The complete opening of the inlet valve therefore enables a large volume flow at the beginning in order to overcome the difference between the setpoint pressure and actual pressure as quickly as possible, with a switch then being made to the intermediate flow to permit accurate and quiet differential pressure control.

In another embodiment, the opening current is applied to the inlet valve as soon as the difference between the actual wheel pressure and the setpoint wheel pressure is greater than a threshold value. For example, a value between 0.5 and 3 bar, in particular around 1 bar, can be selected as the threshold value. Therefore if, in the event of rapid changes in the setpoint value, larger discrepancies between the setpoint value and the actual value of the wheel pressure occur again, the inlet valve is opened completely by re-applying the opening current in order to allow rapid adjustments to the setpoint pressure.

In another embodiment, the inlet valve is controlled without being pulsed, and therefore the pressure equalization of the actual wheel pressure to the setpoint wheel pressure is carried out continuously. This greatly reduces the noise emissions from control of the wheel pressure.

In a further embodiment, it is provided that a follow-up phase begins at a constant setpoint wheel pressure. The electrical valve current is kept to the intermediate current for a follow-up period. Values between 100 ms to 500 ms can be selected as the follow-up period. The actual wheel pressure is thereby set precisely to the setpoint wheel pressure, even in the event of previous errors.

In a further embodiment, at a pressure gradient, i.e., the temporal derivative of the setpoint wheel pressure, smaller than a threshold value, a stabilizing pulse is periodically applied to the inlet valve. As already described, the inlet valves are not in a stable state when the intermediate current is applied. Changes in the flow rate may therefore cause the valve to be fully pushed open. In order to prevent this, switches are made back and forth between the calculated intermediate current and a larger stabilization current. However, the stabilizing pulse with the stabilizing current is applied only for such a short time that the valve plunger does not move appreciably. In particular, pulses with the duration of 1 ms can be applied every 10 ms to 20 ms. A current that is 50 to 500 mA, in particular 100 mA above the intermediate current can be selected as the stabilization current.

In another embodiment, a valve current is calculated on the basis of a pulse control, the valve current is compared with the intermediate current, and the smaller of the two currents is applied to the inlet valve. This ensures that the pressure setting does not take place more slowly by the differential pressure control than by the known pulse control or volumetric control.

Also described herein is a hydraulic braking system for a motor vehicle, having an electrical pressure supply device, at least one wheel brake and a normally open inlet valve assigned to the wheel brake, and a control unit, which, for controlling a hydraulic pressure in the at least one wheel brake, is designed to generate a system pressure by means of the electrical pressure supply device and, by control of the normally open inlet valve, having an opening current characteristic curve, to set a hydraulic pressure, which is lower than the system pressure, in the at least one wheel brake, wherein the inlet valve is opened by application of an opening current below the opening current characteristic curve, and is switched over from the opening current to an intermediate current on the opening current characteristic curve.

### BRIEF DESCRIPTION OF THE DRAWINGS

Further features, advantages and possible applications also result from the description below of exemplary embodiments and the drawings. All of the features described and/or pictorially depicted belong to the subject matter of the disclosure both individually and in any combination, also independently of their summarization in the claims or the back-references thereof.

FIG. 1 schematically shows a braking system according to one exemplary embodiment;

FIG. 2 shows an exemplary diagram of a volumetric pressure control;

FIG. 3 shows an exemplary diagram with the pressure curves of a volumetric pressure control;

FIG. 4 shows an exemplary diagram with an opening current characteristic curve;

FIG. 5 shows a diagram of a differential pressure control according to one exemplary embodiment;

FIG. 6 shows a diagram with the pressure curves of a differential pressure control according to one exemplary embodiment;

FIG. 7 shows an exemplary diagram of noise emissions during the pressure control;

### DETAILED DESCRIPTION

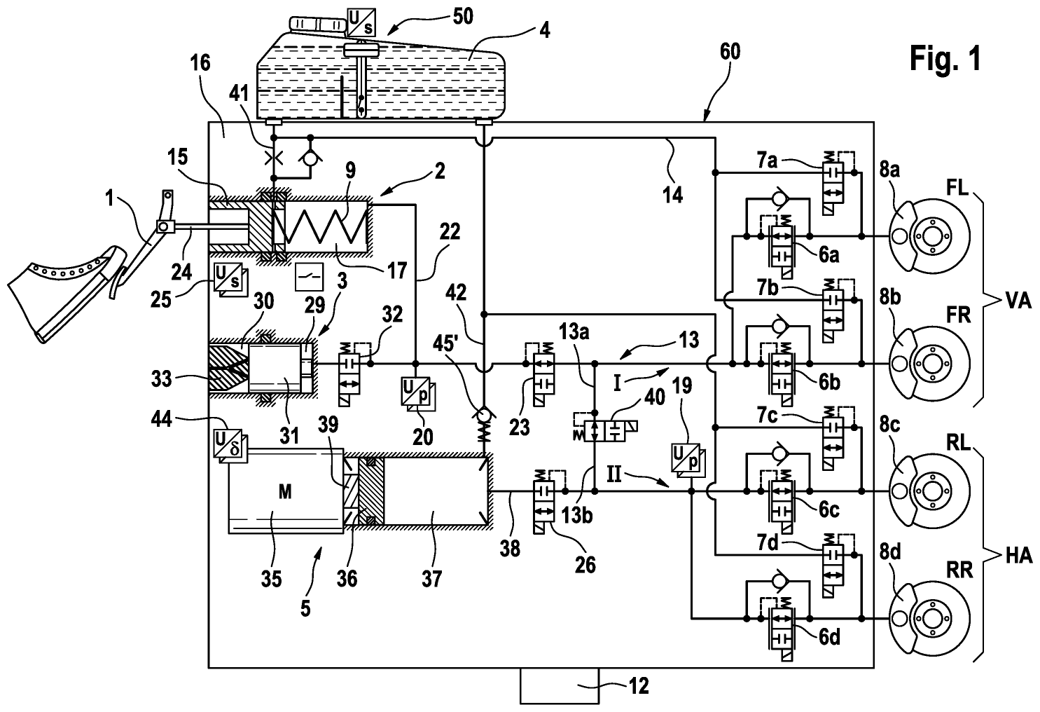

The motor vehicle braking system shown in FIG. 1 includes four hydraulically actuable wheel brakes 8a-8d. The braking system includes a master brake cylinder 2 which is actuable by an actuating pedal or brake pedal 1, a travel simulator or a simulation device 3 which interacts with the master brake cylinder 2, a pressure medium reservoir 4 which is under atmospheric pressure, an electrically controllable pressure supply device 5, and a valve arrangement, comprising wheel-specific brake pressure modulation valves which are configured according to the example as inlet valves 6a-6d and outlet valves 7a-7d. Furthermore, the braking system includes at least one electronic open-loop and closed-loop control unit 12 for controlling the electrically actuable components of the braking system.

According to the example, the wheel brake 8a is assigned to the left front wheel (FL), the wheel brake 8b is assigned to the right front wheel (FR), the wheel brake 8c is assigned to the left rear wheel (RL), and the wheel brake 8d is assigned to the right rear wheel (RR).

The master brake cylinder 2 has, in a housing 16, a master brake cylinder piston 15, which delimits a hydraulic pressure chamber 17, and constitutes a single-circuit master brake cylinder 2. The pressure chamber 17 receives a restoring spring 9 which, with the master brake cylinder 2 unactuated, positions the piston 15 in a starting position. At one end, the pressure chamber 17 is connected to the pressure medium reservoir 4 via radial bores, which are formed in the piston 15, and a corresponding pressure equalization line 41, wherein said bores and line can be shut off by a relative movement of the piston 15 in the housing 16.

At the other end, the pressure chamber 17 is connected by a hydraulic line section (also referred to as first feed line) 22 to a brake supply line 13 to which the input connections of the inlet valves 6a-6d are connected. The pressure chamber 17 of the master brake cylinder 2 is thus connected to all of the inlet valves 6a-6d.

According to the example, no electrically or hydraulically actuable valve is arranged in the pressure equalization line 41 or in the connection between the pressure chamber 17 and the pressure medium reservoir 4.

As an alternative, a normally open, diagnostic valve, connected in parallel between a normally open diagnostic valve and a non-return valve which closes in the direction of the pressure medium reservoir 4, may be disposed in the pressure equalization line 41 or between the master brake cylinder 2 and the pressure medium reservoir 4.

The valve arrangement may also include other hydraulic valves. An isolating valve 23 is arranged between the feed line 22, which is connected to the pressure chamber 17, and the brake supply line 13, or the pressure chamber 17 is connected to the brake supply line 13 via the first feed line 22 with an isolating valve 23. The isolating valve 23 is designed as an electrically actuable, preferably normally open (NO), 2/2-way valve. The hydraulic connection between the pressure chamber 17 and the brake supply line 13 can be shut off by the isolating valve 23.

A piston rod 24 couples the pivoting movement of the brake pedal 1 as a result of pedal actuation to the translational movement of the master brake cylinder piston 15, the actuation travel of which is detected by a travel sensor 25 of preferably redundant design. In this way, the corresponding piston travel signal is a measure of the brake pedal actuation angle. It represents a braking demand of a vehicle driver.

A pressure sensor 20, which is connected to the first feed line 22, detects the pressure built up in the pressure chamber 17 as a result of a displacement of the piston 15. This pressure value can also be evaluated to characterize or determine the braking demand of the vehicle driver. As an alternative to a pressure sensor 20, use can also be made of a force sensor 20 for determining the braking demand of the vehicle driver.

According to the example, the simulation device 3 is of hydraulic configuration and is hydraulically coupled to the master brake cylinder 2. The simulation device 3 substantially has, for example, a simulator chamber 29, a simulator rear chamber 30 and a simulator piston 31 which separates the two chambers 29, 30 from each other.

The simulator piston 31 is supported on a housing by an elastic element 33 (e.g. simulator spring) which is arranged in the simulator rear chamber 30 (which is dry according to the example). According to the example, the hydraulic simulator chamber 29 is connected to the pressure chamber 17 of the master brake cylinder 2 by an electrically actuable, preferably normally closed simulator enable valve 32.

The braking system comprises an inlet valve 6a-6d and an outlet valve 7a-7d for each hydraulically actuable wheel brake 8a-8d, the inlet valves and outlet valves being hydraulically interconnected in pairs via center connections and connected to the wheel brake 8a-8d. A non-return valve, not specifically designated, which opens in the direction of the brake supply line 13, is connected in parallel to each of the inlet valves 6a-6d. The output connections of the outlet valves 7a-7d are connected to the pressure medium reservoir 4 via a common return line 14. The valves, in particular the inlet valves, may be seat valves. Such seat valves have only two stable conditions, fully open or fully closed, when there is no flow. If flow passes through a seat valve, in addition to the spring force, the magnetic force and the compressive force, there is also a flow force resulting from the change in pressure as a consequence of the flow. By a suitable spring selection and also the electromagnetic properties (residual air gap, coil), a valve can be designed in such a way that even a plurality of stable positions are produced by the flow forces. However, this is not comparable to the quality of a proportional valve and there are typically problems in such valves with the plunger tending to vibrate in the intermediate positions, which in turn leads to noise and vibrations (NVH).

The electrically controllable pressure supply device 5 is in the form of a hydraulic cylinder-piston arrangement (or a single-circuit, electro-hydraulic actuator) or linear actuator, the piston 36 of which is actuable by an electric motor 35, schematically indicated, with the intermediate connection of a rotary translation transmission 39, likewise schematically illustrated. The piston 36 delimits the single pressure chamber 37 of the pressure supply device 5. A rotor position sensor, merely schematically indicated, which serves to detect the rotor position of the electric motor 35 is denoted by reference sign 44.

A line section (also referred to as second feed line) 38 is connected to the pressure chamber 37 of the electrically controllable pressure supply device 5. The supply line 38 is connected to the brake supply line 13 via an electrically actuable, preferably normally closed, sequence valve 26 as part of the valve arrangement. The sequence valve 26 allows the hydraulic connection between the pressure chamber 37 of the electrically controllable pressure supply device 5 and the brake supply line 13 (and thus the input connections of the inlet valves 6a-6d) to be opened and shut off in a controlled manner.

The actuator pressure produced by the action of force of the piston 36 on the pressure medium enclosed in the pressure chamber 37 is fed into the second feed line 38. In a “brake-by-wire” operating mode, in particular in a fault-free state of the braking system, the feed line 38 is connected to the brake supply line 13 via the sequence valve 26. In this way, there is, during normal braking, a build up and a reduction in wheel brake pressure for all of the wheel brakes 8a-8d owing to the forward and backward movement of the piston 36.

In the case of a reduction in pressure by backward movement of the piston 36, the pressure medium previously displaced from the pressure chamber 37 of the pressure supply device 5 into the wheel brakes 8a-8d flows back again into the pressure chamber 37 in the same way.

Alternatively, wheel brake pressures which differ in a wheel-specific way can be simply set by means of the inlet and outlet valves 6a-6d, 7a-7d. In the case of a corresponding reduction in pressure, the portion of pressure medium discharged via the outlet valves 7a-7d flows via the return line 14 into the pressure medium reservoir 4.

Additional pressure medium can be drawn into the pressure chamber 37 owing to a backward movement of the piston 36 with the sequence valve 26 closed by way of pressure medium being able to flow out of the reservoir 4 into the actuator pressure chamber or pressure chamber 37 via the line 42 with a non-return valve 53, which opens in a flow direction to the actuator 5. According to the example, the pressure chamber 37 is additionally connected, in an unactuated state of the piston 36, to the pressure medium reservoir 4 via one or more breather holes. This connection between the pressure chamber 37 and pressure medium reservoir 4 is disconnected upon a (sufficient) actuation of the piston 36 in the actuating direction 27.

In the brake supply line 13, an electrically actuable, normally open circuit isolating valve 40 is arranged, through which the braking system is divided into two hydraulic partial circuits. The brake supply line 13 is divided into a first line section 13a, which is connected (via the isolating valve 23) to the master brake cylinder 2, and a second line section 13b in the second hydraulic partial circuit, which is connected (via the sequence valve 26) to the pressure supply device 5. The first line section 13a is connected to the inlet valves 6a, 6b of the wheel brakes 8a, 8b, and the second line section 13b is connected to the inlet valves 6c, 6d of the wheel brakes 8c, 8d.

With the circuit isolating valve 40 open, the braking system is of single-circuit design. By closing the circuit isolating valve 40, the braking system, in particular controlled according to the situation, can be separated or divided into two hydraulic partial circuits, the brake circuits I and II. Here, in the first brake circuit I, the master brake cylinder 2 is connected (via the isolating valve 23) to only the inlet valves 6a, 6b of the wheel brakes 8a, 8b of the front axle VA, and, in the second brake circuit II, the pressure supply device 5 is connected (with the sequence valve 26 open) to only the wheel brakes 8c and 8d of the rear axle HA.

With the circuit isolating valve 40 open, the input connections of all of the inlet valves 6a-6d can be supplied by means of the brake supply line 13 with a pressure which corresponds to the brake pressure which is provided by the pressure supply device 5 in a first operating mode (e.g., “brake-by-wire” operating mode). In a second operating mode (e.g., in a de-energized fallback operating mode), the pressure of the pressure chamber 17 of the master brake cylinder 2 can be applied to the brake supply line 13. This pressure is also referred to as system pressure because it is applied to all of the inlet valves 6a-6d when the circuit isolating valve 40 is open.

The braking system advantageously includes a level-measuring device 50 for determining a pressure medium level/filling level in the pressure medium reservoir 4.

According to the example, the hydraulic components, namely the master brake cylinder 2, the simulation device 3, the pressure supply device 5, the valve arrangement with the hydraulic valves 6a-6d, 7a-7d, 23, 26, 40, and 32 and also the hydraulic connections, including the brake supply line 13, are arranged together in a hydraulic open-loop and closed-loop control unit 60 (HCU). The electronic open-loop and closed-loop control unit (ECU) 12 is assigned to the hydraulic open-loop and closed-loop control unit 60. The hydraulic and the electronic open-loop and closed-loop control units 60, 12 may be configured as one unit (HECU).

The braking system includes a pressure sensor 19 or system pressure sensor for detecting the pressure provided by the pressure supply device 5. Here, the pressure sensor 19 is arranged downstream of the sequence valve 26, as seen from the pressure chamber 37 of the pressure supply device 5.

In addition to the hydraulic actuation, the two rear wheel brakes 8c, 8d are each equipped with integrated parking brakes 48c, 48d, which are designed as electromechanical parking brakes.

In a normal operating mode, the isolating valve 23 is closed and the sequence valve 26 and the circuit isolating valve 40 are open, and therefore the hydraulic pressure in all of the wheel brakes 8a to 8d is set by the linear actuator 5. To control different brake pressures in the individual wheel brakes 8a-8d, the respective inlet valves 6a-6d have to be controlled accordingly.

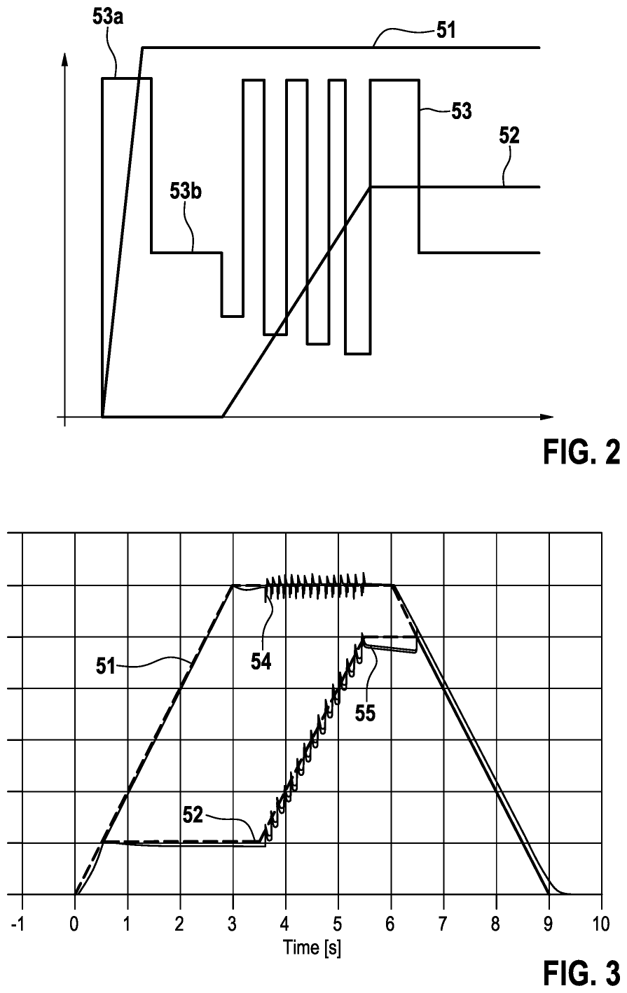

Such a control of the inlet valves, as is known from the prior art, is shown in FIG. 2. A setpoint pressure of the front axle 51 is higher than a setpoint pressure of the rear axle 52. The setpoint pressure of the front axle 51 can therefore be set directly by the linear actuator 5 when the inlet valves 6a, 6b of the wheel brakes 8a, 8b of the front axle are fully open. The setpoint pressure of the rear axle 52, on the other hand, is controlled by pulsed control of the inlet valves 6c, 6d. As shown in FIG. 2, at the beginning only the setpoint pressure of the front axle 51 increases while the setpoint pressure of the rear axle remains at zero. Correspondingly, the inlet valves 6c, 6d of the rear axle are supplied with a closing current 53a, which reliably closes the inlet valve. After a short period of time, this closing current is reduced to a holding current 53b, which is sufficient to keep the inlet valve reliably closed.

As soon as the setpoint pressure of the rear axle (p_{req}) 52 increases, a differential volume dV is determined in said “volumetric control” in a first step from the pressure requirement p_{req} and the currently estimated wheel pressure p_{mod}. A pressure volume characteristic curve (pV characteristic curve) stored in the braking system is used for this purpose.

$$dV = pV ( {p}_{req} ) - pV ( {p}_{mod} )$$

Furthermore, a desired volume flow q is determined from the setpoint pressure gradient p_{grad} and the derivative of the pV characteristic curve.

$$q = \frac{dp}{dV} {p}_{grad}$$

In a second step, the electrical current for the inlet valve is then determined, which enables the volume flow q for the currently prevailing differential pressure via the valve. In order to convey the differential volume dV via the valve by means of the volume flow q, the valve is kept open for a valve activation time Tau=dV/q. After the valve activation time Tau, a closing current is applied to the inlet valve, through which the inlet valve is closed completely again. If the setpoint pressure increases further, as in the example shown in FIG. 2, there is in turn a difference between the new setpoint pressure 52 (p_{req}) and the current actual wheel pressure. Accordingly, the above steps are repeated and another opening pulse is applied to the inlet valve. If the setpoint value of the rear axle 52 then remains constant, the holding current is set after the last closing pulse and keeps the inlet valve in the closed state.

The pressure curves resulting from the volumetric control are shown in FIG. 3. At the beginning, the actual wheel pressure 54 of the front axle very precisely follows the setpoint wheel pressure 51, since this is set directly by the linear actuator 5. As soon as the setpoint pressure of the rear axle 52 also increases, and the volumetric control opens the inlet valve in pulsed form, both pressure of the rear axle 55 on the wheel and pressure of the front axle 54 on the wheel result in a multiplicity of small pressure peaks.

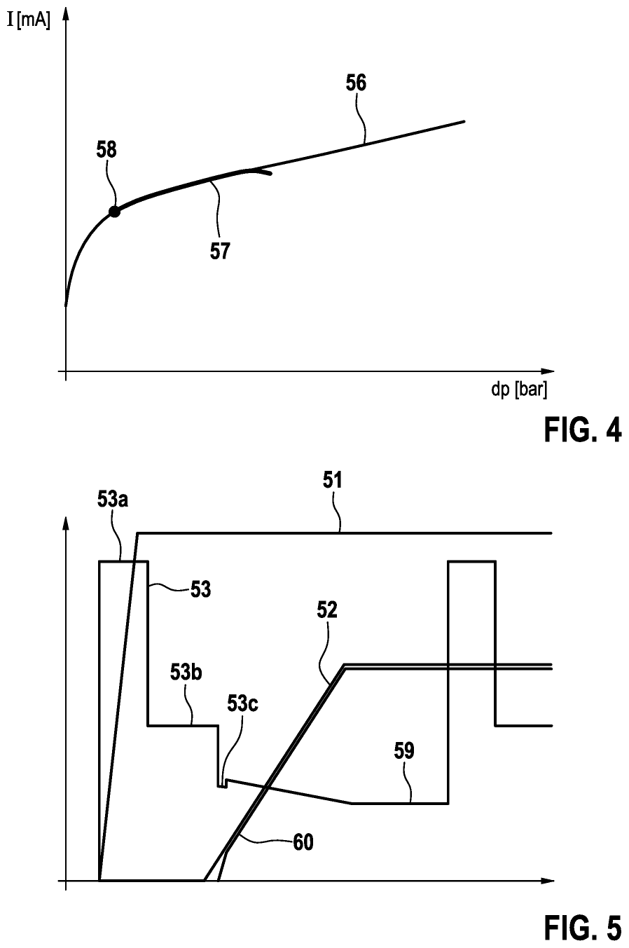

FIG. 4 shows an opening current characteristic curve of a typical inlet valve 6. The opening current characteristic curve 56 shows a trend for various differential pressures DP via the inlet valve the current ranges for which the inlet valve is closed (above the opening current characteristic curve) and currents for which the inlet valve is closed (below the opening current characteristic curve).

FIG. 5 shows the differential pressure control according to the one embodiment of the disclosure as analogous to FIG. 2. The setpoint pressure curves 51 and 52 of the front axle and the rear axle are identical to in FIG. 2. Accordingly, the current curve 53 again also has a pulse 53a, followed by the holding current 53b to keep the inlet valves 6c, 6b of the rear axle completely closed, while the pressure requirement of the setpoint pressure 52 of the rear axle still remains at zero. As soon as the setpoint pressure 52 of the rear axle increases, a first opening pulse 53c is connected. For this purpose, the valve current and the valve activation time Tau can be calculated, as described above. However, a switch is not now made from this opening current to a closing current; instead, a valve current on the opening current characteristic curve 56 is selected. Inlet valve 6 is correspondingly neither in a defined closed nor in a defined open state; rather, the inlet valve 6 is in an intermediate state. The valve current is selected from the opening current characteristic curve 56 for a differential pressure, which is calculated between the system pressure and the setpoint value 52. This accordingly does not directly involve the actual value of the pressure difference, but a setpoint value of the pressure difference. However, since the setpoint value and actual value are close together, the difference is small. In the event of very slow changes in the setpoint value 52, precisely as much volume flows through the inlet valve 6 such that the actual wheel pressure 60 can follow the setpoint wheel pressure 52 exactly. The differential pressure between the setpoint value 52 of the rear axle and the setpoint value 51 of the front axle gradually decreases. As shown in FIG. 4, the valve current 57 therefore moves to the left on the opening current characteristic curve 56.

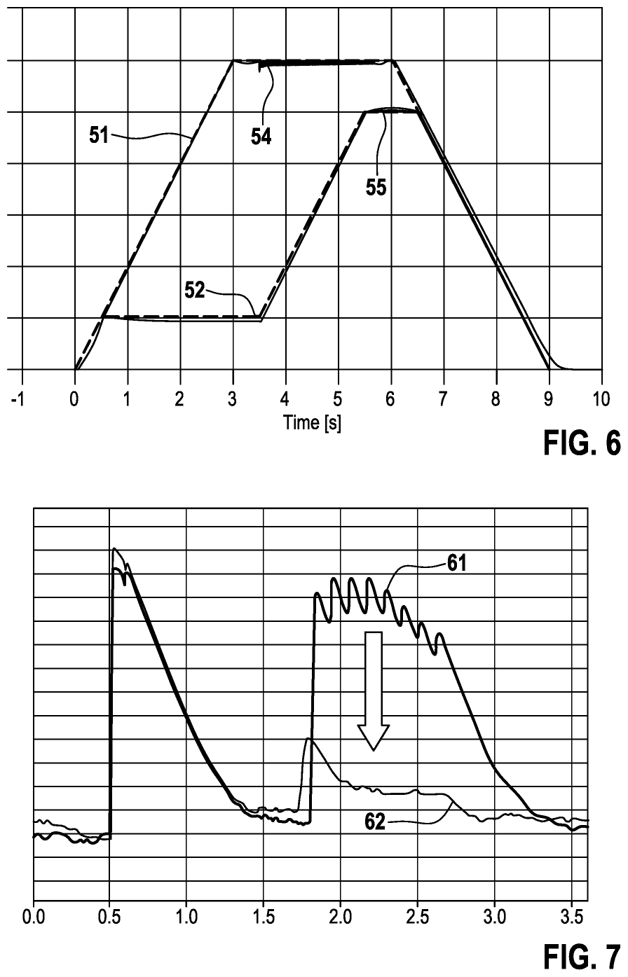

As can be deduced from FIG. 6, the actual wheel pressures 54, 55 of the front axle and the rear axle follow the stipulations by the setpoint values 51, 52 much more accurately. In particular, it should be noted that the control of the valve current on the opening current characteristic curve depends solely on the pressure difference between the system pressure and the setpoint value 52 p_{req} for the respective wheel brake. In particular, the actual wheel pressure, which in general cannot be measured directly, is not included in the pressure control but instead originates from model calculations. The pV characteristic curve, which can exhibit large inaccuracies, is not included in the pressure control in this area either. This significantly improves the accuracy and robustness of the pressure control.

FIG. 7 additionally shows the noise emission 61 during the pressure setting by the volumetric control and the noise emission 62 during the pressure setting by differential pressure control. While the noise emissions are still equivalent at the beginning, it turns out that, in the volumetric control, the rapid opening and closing of the inlet valves creates a multiplicity of noise peaks, which add up to a high noise level. With the differential pressure control, these peaks do not exist and a much quieter noise level is achieved.

### LIST OF REFERENCE SIGNS

1 Brake pedal
2 Master brake cylinder
3 Simulation device
4 Pressure medium reservoir
5 Pressure supply device
6 a to d Inlet valves
7 a to d Outlet valves
8 a to d Wheel brake
9 Restoring spring
12 Control system
13 Brake supply line
14 Return line
16 Housing
17 Pressure chamber
19 System pressure sensor
20 Master cylinder pressure sensor
22 First feed line
23 Isolating valve
24 Piston rod
25 Travel sensor
26 Sequence valve
29 Simulator chamber
30 Simulator rear chamber
31 Simulator piston
32 Simulator enable valve
33 Elastic element
35 Piston
36 Electric motor
37 Pressure chamber
38 Feed line
39 Rotation-translation mechanism
40 Circuit isolating valve
41 Pressure equalization line
42 Line
44 Rotor position sensor
45 Non-return valve
50 Level sensor
51 Setpoint pressure of front axle
52 Setpoint pressure of rear axle
53 Valve current of inlet valve pulsed
54 Pressure curve of front axle
55 Pressure curve of rear axle
56 Opening current characteristic curve
57 Pressure rise on current curve
58 Follow-up period of current value
59 Follow-up period
60 Model pressure
61 Volumetric control of noise emission
62 Pressure difference control of noise emission

1-11. (canceled)

12. A method for controlling a hydraulic pressure in at least one wheel brake of a hydraulic motor vehicle braking system, said method comprising:
generating a system pressure with an electrical pressure supply device;
setting a required hydraulic pressure, lower than the system pressure, at the at least one wheel brake by controlling a normally open inlet valve having an opening current characteristic curve;
wherein the inlet valve is opened by application of an opening current, below the opening current characteristic curve, and is switched over from the opening current to an intermediate current on the opening current characteristic curve.

13. The method as set forth in claim 12, wherein the intermediate current is determined from the opening current characteristic curve based on a pressure difference between the system pressure and the required hydraulic pressure.

14. The method as set forth in claim 12, wherein the opening current is set based on at least one of a current pressure difference via the inlet valve and a required volume flow through the inlet valve.

15. The method as set forth in claim 14, wherein the pressure difference via the inlet valve is determined from the system pressure and the actual wheel pressure, wherein the actual wheel pressure is determined from a model calculation.

16. The method as set forth in claim 12, wherein the switching over from the opening current to the intermediate current is performed in response to the actual wheel pressure reaching the setpoint wheel pressure.

17. The method as set forth in claim 12, wherein the opening current being applied to the inlet valve is performed in response to the difference between the actual wheel pressure and the setpoint wheel pressure being greater than a threshold value.

18. The method as set forth in claim 12, wherein the inlet valve is controlled without being pulsed, and therefore the pressure equalization of the actual wheel pressure to the setpoint wheel pressure is carried out continuously.

19. The method as set forth in claim 12, wherein in a follow-up phase, in which the setpoint wheel pressure remains constant, the electric valve current is kept to the intermediate current for a follow-up period.

20. The method as set forth in claim 12, further comprising periodically applying a stabilizing pulse to the inlet valve in response to a pressure gradient being smaller than a threshold value.

21. The method as set forth in claim 12, further comprising calculating a valve current based on a pulse control, wherein the valve current is compared with the intermediate current, and the smaller of the two currents is applied to the inlet valve.

22. A hydraulic braking system for a motor vehicle, comprising:
an electrical pressure supply device;
at least one wheel brake and a normally open inlet valve assigned to the at least one wheel brake, the normally open inlet valve having an opening current characteristic curve;
a control unit for controlling a hydraulic pressure in the at least one wheel brake, configured to
generate a system pressure with the electrical pressure supply device,
control the normally open inlet valve to set a hydraulic pressure, which is lower than the system pressure, in the at least one wheel brake,
wherein the inlet valve (6a, b, c, d) is opened by application of an opening current below the opening current characteristic curve, and is switched over from the opening current to an intermediate current on the opening current characteristic curve.
